(19) United States
(12) Patent Application Publication
(10) Pub. No.: US 2026/0022047 A1
(43) Pub. Date: Jan. 22, 2026

(54) MOBILE WATER FILTRATION SYSTEM

(71) Applicant: HC RISK REDUCTION, INC., Marlborough, MA (US)

(72) Inventors: Michael Matros, Marlborough, MA (US); Caitlin Matros, Marlborough, MA (US)

(21) Appl. No.: 19/020,664

(22) Filed: Jan. 14, 2025

Related U.S. Application Data
(60) Provisional application No. 63/673,390, filed on Jul. 19, 2024.

(51) Int. Cl. C02F 9/20; C02F 1/00; C02F 1/28; C02F 1/66; C02F 101/10; C02F 101/36; C02F 103/00

(52) U.S. Cl. CPC C02F 9/20; C02F 1/001; C02F 2001/007; C02F 1/283; C02F 1/66; C02F 2101/10; C02F 2101/36; C02F 2103/002; C02F 2201/005; C02F 2201/008; C02F 2301/022

(57) ABSTRACT

A mobile water filtration system for use with a mobile firefighter gear cleaner. The mobile water filtration system is self-contained and equipped to condition the water used for washing firefighter gear. The mobile firefighter gear cleaner requires make-up water of a particular quality, and the discharge water becomes contaminated after the process. The instant invention discloses a process using a series of filters for use in decontamination of the wash water, allowing for reuse in the system or for discarding the water without adversely affecting the environment.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/673,390, entitled “MOBILE WATER FILTRATION SYSTEM”, filed Jul. 19, 2024. The contents of the above referenced application are incorporated herein by reference in its entirety.

### FIELD OF THE INVENTION

This invention is directed to the field of remote cleaning of firefighting personal protective equipment (PPE) and, in particular, to a mobile water filtration system for use with a mobile firefighter PPE equipment cleaner.

### BACKGROUND OF THE INVENTION

Applicant's U.S. Pat. Nos. 11,578,455 and 11,879,203 are directed to a Mobile Firefighter Gear Cleaner, the contents of which are incorporated herein by reference. Applicant's Mobile Firefighter Gear Cleaner is for use in cleaning firefighter contaminated gear using mobile equipment. Firefighters are the first responders to any type of fire, wherein their gear can be exposed to toxic elements. For instance, a warehouse containing plastics may release toxic dioxins and furans should a fire occur. The toxic elements become airborne and may coat the firefighter Personal Protective Equipment (PPE), subsequently exposing the firefighters to toxins and carcinogens upon being released by the fire.

PPE includes, the fire helmet used by firefighters to protect their heads from falling objects and flying debris during a firefight or rescue operation. Helmets also provide protection from heat, smoke and toxic gases generated by fires. A face shield protects a firefighter's eyes from flying embers, sparks and other debris while fighting fires inside structures. Fire boots to protect feet from burns caused by hot materials such as melted plastics, paper, wood or other combustible objects that may have been trapped inside a building. A firefighter's suit protects his body from burns through direct skin contact with flames and heat sources during firefighting operations. It also provides protection against chemicals such as ammonia, hydrochloric acid, sulfur dioxide and chlorine gas released into the environment while fighting fires at hazardous waste facilities or chemical manufacturing plants. Gloves are worn by firefighters to protect their hands from cuts and abrasions caused by falling objects during rescue operations involving escape of people trapped inside structures like buildings after a fire breaks out there.

Previously known equipment cleaners were directed to firehouse positioned gear cleaning machines that are expensive considering installation, service, and operating requirements. Further, gear cleaning machines take up valuable space in the firehouse. In addition, gear needs to be cleaned and properly stored in accordance with manufacturer recommendations, which requires training. An average gear cleaning machine can wash 2-4 sets of gear at a time. A typical fire has 16-20 firefighters on the scene, which means it would take 16-20 hours to clean this gear after a single exposure using conventional cleaning equipment found at a firehouse.

Problems regarding the cleaning of PPE include timing while PPE is not accessible, costs, disposal of contaminated water and the like. While Applicant's Mobile Firefighter Gear Cleaner system addresses most of those issues, Applicant's Mobile Firefighter Gear Cleaner system can be kept at a location in need, wherein adequate makeup water may not be available, either in quantity or quality.

What is needed in the industry is a mobile water filtration system for use with mobile cleaning units or firehouses wherein the water used to clean the clothing is properly pretreated and includes a provision to reuse water, or provide sufficient post use treatment wherein the used water can be discarded without harming the environment.

### SUMMARY OF THE INVENTION

Disclosed is a mobile water filtration system for coupling to a mobile firefighter gear cleaner. The mobile firefighter gear equipment requires sufficient water to clean and sanitize firefighter gear in the field. Such gear must be washed, dried, sanitized and tracked to meet standards including all firefighter PPE, helmets, jackets, pants, boots, gloves, hand tools, and the like SCBA equipment.

The mobile water filtration system of the instant invention conditions the water for cleaning the firefighter gear by a series of filters and conditioners, wherein the water is cleaned and suitable for reuse or disposal without risk of contaminating the environment. The mobile water filtration system can replenish the water tanks on the mobile firefighting gear truck so as to deliver clean water to the washing machines. The mobile water filtration system may also reduce the size of the gray water tanks and reduce the amount of makeup water required or assure discharged water meets State and Federal guidelines.

An objective of the invention is to provide a mobile water filtration system that will condition, recycle, or dispose of water used to clean firefighter gear PPE.

Another objective of the invention is to provide a mobile water filtration system that allows for extended remote operation with little or no makeup water.

Still another objective of the invention is to provide a mobile filtration system designed to be self sufficient and operate at an incident for extended periods of time and eliminate the need to expel waste water.

Yet still another objective of the invention is to provide conditioning of waste water that allows for environmentally safe discharge.

Another objective of the invention is to provide a support vehicle to support Applicant's mobile gear cleaner to provide a full service solution to the fire service and allow the unit to run without limitations or without having to dump waste water from a holding tank. The solution includes filtering fresh water coming into the mobile gear cleaner improving water clarity, removing metals, and providing a consistent pH to allow for better cleaning and a better end product.

The mobile water filtration system of the instant invention provides a stand-alone process that is constructed and arranged to support the Applicant's mobile gear cleaner or to operate independently in separate operations where consistent clean water is a critical component.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a flow diagram of the mobile cleaning apparatus of the instant invention;

FIG. 2 is a perspective view of a dump tank;

FIG. 3 is a top view of the dump tank; and

FIG. 4 is a cross-sectional end view of the dump tank.

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

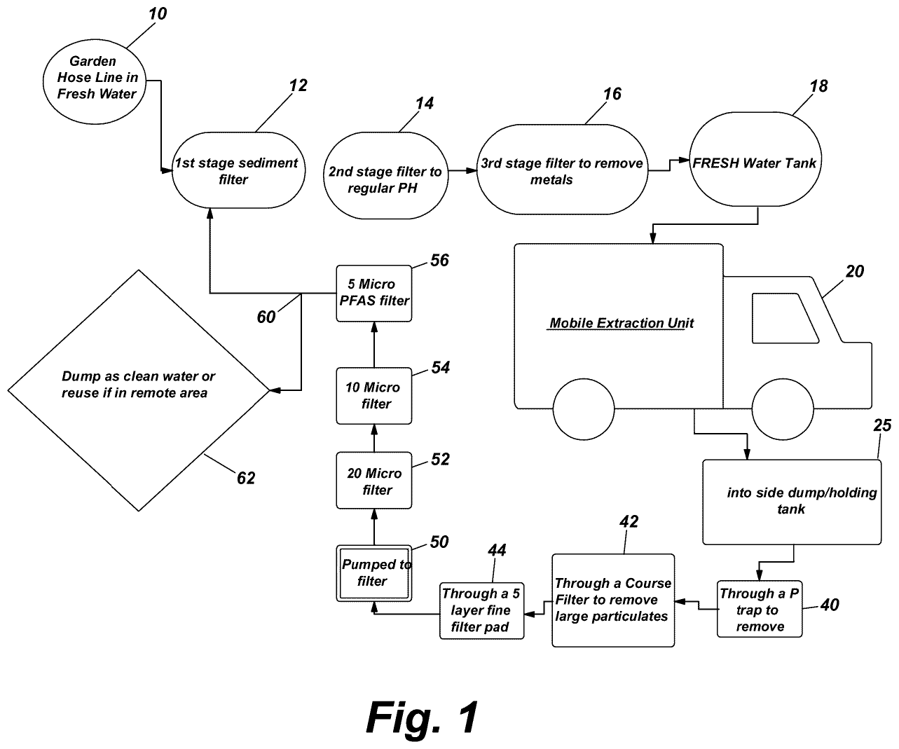

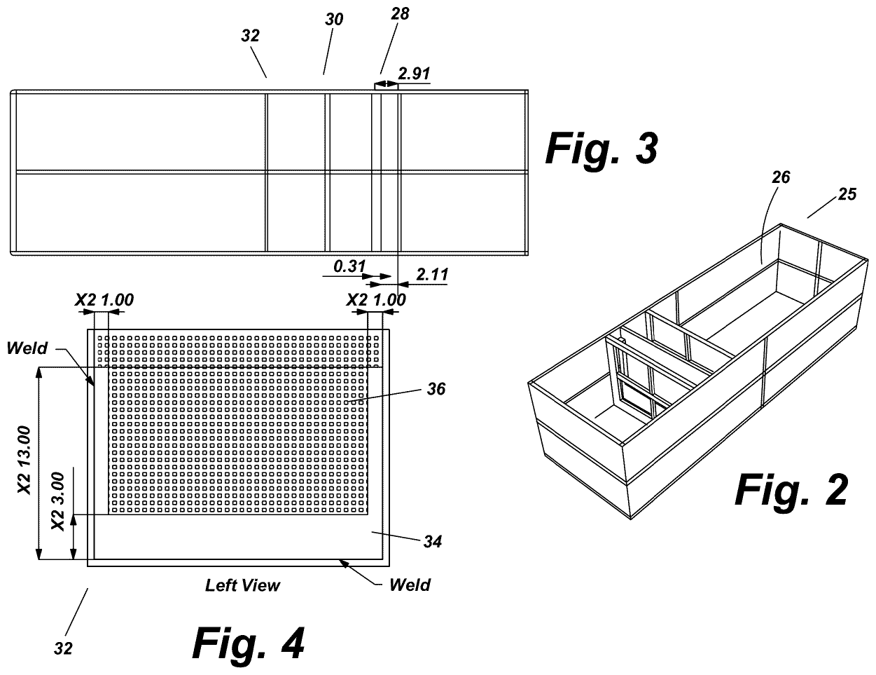

Referring to the FIG. 1, disclosed is a mobile water filtration system for use with a mobile firefighter gear cleaner apparatus. The mobile water filtration system draws water from a source 10, commonly a flexible hose coupled to a fresh water supply. The system comprises a first stage sediment filter 12 having an output coupled to a second stage filter 14 constructed and arranged to regulate the water passing through to a predefined pH range. The optimum pH range is between a neutral 7 to an alkaline 10.5. Preferably the range is between 9 and 10.5, the alkaline range is effective at breaking down organic stains from fabric. A pH closer to neutral is gentler on skin to avoid skin irritation. A third stage filter 16 is constructed and arranged to remove metals from the pH adjusted filtered water for direction into a fresh water holding tank 18. The holding tank allows for batch cleaning of the firefighting gear, allowing the first, second, and third stage filter to operate at a lower flow rate providing higher efficiency in element removal, and lower cost in equipment and operation. Upon demand, the filtered water from the holding tank is directed to the mobile firefighter gear cleaner system 20.

After the cleaning process, described in Applicant's U.S. Pat. Nos. 11,578,455 and 11,879,203 incorporated herein by reference, the water used in cleaning is contaminated with matter drawn off the firefighter gear and directed to a dump/holding tank 25. The tank 25 is fluidly coupled to the mobile vehicle for receipt of contaminated wash water from the mobile firefighter gear cleaner system. Referring to the Figs in general, dump tank 25 includes a first chamber 26 which operates as a settlement area before directing the wash water through a series of screens 28, 30, 32 for removal of large particulates by settling which can be enhanced by coagulation. Each screen has a lower settlement barrier 34 with a series of apertures 36 to cause a laminar flow to enhance settlement of particulates. In operation, the first barrier provides a soap separation chamber.

The dump tank 25 is compact with dimensions of about 6′ long, 22″ high and 22″ wide. The compact size allows the dump tank 25, including the filters used for the make-up water 12, 14, and 16 and the filters used for the recycling the wash water 42, 44, 52, 54, and 56 to be mounted on the mobile extraction unit.

Recovery of wash water used in the cleaning process is drawn from the dump tank 25 using a P-trap 40 and directed through a course filter 42 for removal of large particulates and a fine filter 44 made of a five layer filter pad.

A pump 50 is used for transferring the wash water filtered through the dump tank 25 and passes the wash water through a first 20 micron filter 52 and a 10 micron filter 54 placed in series, followed by a 5 micron filter 56 used to removed PFAS (Per- and Polyfluoroalkyl Substances) elements from the reclaimed water. PFAS are defined as a group of synthetic chemicals used in firefighting foams, certain types of plastics, and various products including water repellent fabrics. Burning of these items containing PFAS can release hazardous compounds which can settle and stick on the firefighting gear. In one embodiment, PFAS filters used herein are activated carbon filters used to adsorb PFAS molecules, especially longer-chain compounds, onto the surface of activated carbon. Alternatively, Ion Exchange Resins may be used to trap PFAS molecules through an ion exchange process. Ion exchange is especially effective for removing shorter-chain PFAS that are harder to capture with carbon alone.

A directional valve 60 is used to direct the filtered water to the first stage filter 12 for use in recycling of the water for use in the mobile extraction unit 20, or directed to a discharge location 62. The system is constructed and arranged to be used in combination with the Applicant's mobile extraction unit and operated at an incident. The recycling allows the unit to remain at an incident for extended periods of time by eliminating the need to dump waste water after each cleaning cycle. Further, the filtration elements are designed to accept water from different sources using the filtration elements to keep water quality consistent. Wash water is cleaned to the point where it can be recycled a number of times for reuse during the cleaning process.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A water filtration system for a mobile extraction unit used in firefighter gear cleaning comprising:
a dump tank secured to said mobile extraction unit, said dump tank having a rectangular shaped bottom wall with two side walls and two end walls extending upward therefrom forming a first chamber for receipt of wash water;
at least two divider walls extending between said side walls, each divider wall having a plurality of apertures constructed and arranged to induce a laminar flow therethrough to cause particle in said wash water to settle to the bottom wall;
a course filter having an inlet fluidly coupled to an outlet of said dump tank for removal of large particulates;
a fine filter pad fluidly coupled to an outlet of said course filter;
a pump for transferring filtered wash water through a series of micron filters consisting of a 20 micron filter, a 10 micron filter, a 5 micron PFAS before return to the mobile extraction unit wherein the filtered wash water is suitable for use as make-up water for firefighter gear cleaning.

2. The water filtration system for a mobile extraction unit according to claim 1 including a fresh water filtration comprising a first stage settlement filter, a second stage filter to regulate pH, and a third stage filter constructed to remove metals from said pH adjusted filtered water.

3. The water filtration system for a mobile extraction unit according to claim 2 including wherein said fresh water filtration is supplemented with said filtered wash water.

4. The water filtration system for a mobile firefighter gear cleaner system according to claim 1 including a directional valve to direct said filtered wash water to said first stage filter housing or to a discharge location.

5. A water filtration system for a mobile firefighter gear cleaner system according to claim 1 wherein said PFAS filter contains activate carbon media.

6. A water filtration system for a mobile firefighter gear cleaner system according to claim 1 wherein said dump tank is about 6′ long, 22″ high and 22″ wide.

7. A water filtration system for a mobile firefighter gear cleaner system according to claim 1 wherein said file filter pad consists of five layers.
